(19) United States
(12) Patent Application Publication
(10) Pub. No.: US 2024/0316495 A1
(43) Pub. Date: Sep. 26, 2024

(54) METHANE CONVERSION REACTOR HAVING FORCED AIR DELIVERY

(71) Applicant: Thermon Canada Inc., Edmonton (CA)

(72) Inventors: Jarek SZYNKARCZUK, Edmonton (CA); Mahima Saxena, Edmonton (CA)

(21) Appl. No.: 18/189,566

(22) Filed: Mar. 24, 2023

Related U.S. Application Data
(60) Provisional application No. 63/491,211, filed on Mar. 20, 2023.

(51) Int. Cl. B01D 53/94; B01D 53/34

(52) U.S. Cl. CPC B01D 53/944; B01D 53/343; B01D 53/9495; B01D 2255/904; B01D 2256/22; B01D 2257/7025

(57) ABSTRACT

A methane conversion reactor (MCR) comprises a catalytic converter having a housing including a first face open to atmosphere for receiving air and a second face having a methane inlet for receiving the methane. The MCR also comprises a catalyst pad for catalytically reacting the methane with oxygen in the air to produce carbon dioxide and water vapor. The MCR further includes a centrifugal fan disposed along a side of the housing of the catalytic converter for forcing the air into the housing of the catalytic converter to improve reaction efficiency and to cool the catalyst pad. The MCR includes an electric motor to drive the centrifugal fan in response to a fan control signal and a microcontroller for receiving a temperature signal from a temperature sensor and for generating the fan control signal to adjust an air flow rate in response to the temperature signal.

### TECHNICAL FIELD

The present invention relates to a methane conversion reactor and related method of converting methane to carbon dioxide and water vapor.

### BACKGROUND

Methane (CH₄) emissions from industrial processes such as oil and gas plants are an environmental concern. Methane emissions may be due to venting and flaring. In addition, some methane emissions are fugitive emissions that come from valves, pumps, regulators, joints, flanges, meters or other equipment that leak gas. In oil and gas sites that lack a ready supply of compressed air pressurized, methane may be employed instead of compressed air to drive pneumatic equipment. Release of this methane from such equipment causes environmental damage. Methane is many times more deleterious as a greenhouse gas (GHG) than carbon dioxide. Conversion of methane to less pernicious carbon dioxide is thus extremely important to prevent GHG-induced climate change.

An efficient methane conversion reactor and method is thus highly desirable to attenuate the effects of methane emissions on GHG-induced climate change.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

The present specification discloses a methane conversion reactor for reacting methane with oxygen to convert the methane to carbon dioxide and water vapor, the methane conversion reactor comprising a catalytic converter having a housing defining an enclosure, the housing having a first face open to atmosphere for receiving air and having a second face that includes a methane inlet for receiving the methane into the enclosure defined by the housing of the catalytic converter. The methane conversion reactor further includes a catalyst pad disposed within the housing of the catalytic converter for catalytically reacting the methane with oxygen in the air to produce the carbon dioxide and the water vapor. The methane conversion reactor also includes a centrifugal fan disposed along a side of the housing of the catalytic converter for forcing the air into the housing of the catalytic converter to improve reaction efficiency and to cool the catalyst pad. The methane conversion reactor includes an electric motor to drive the centrifugal fan in response to a fan control signal and a microcontroller for receiving a temperature signal from a temperature sensor and for generating the fan control signal to adjust an air flow rate in response to the temperature signal.

The present specification also discloses a method of method of converting methane to carbon dioxide and water vapor, the method comprising a step of receiving air into a catalytic converter having a housing defining an enclosure, the housing having a first face open to atmosphere and a step of receiving the methane into the enclosure via a methane inlet in a second face of the housing. The method entails catalytically reacting the methane with oxygen in the air to produce the carbon dioxide using a catalyst pad disposed within the housing of the catalytic converter. The method entails forcing the air into the housing of the catalytic converter to improve reaction efficiency and to cool the catalyst pad using a centrifugal fan disposed along a side of the housing of the catalytic converter. The method entails driving, using an electric motor, the centrifugal fan in response to a fan control signal. The method further entails receiving, by a microcontroller, a temperature signal from a temperature sensor. The method further includes generating the fan control signal to adjust an air flow rate in response to the temperature signal.

### BRIEF DESCRIPTION OF THE DRAWINGS

These and other features of the disclosure will become more apparent from the description in which reference is made to the following appended drawings.

FIG. 1 is a frontal perspective view of a methane conversion reactor in accordance with an embodiment of the present invention.

FIG. 2 is a side view of the methane conversion reactor of FIG. 1.

FIG. 3 is a frontal perspective view of a methane conversion reactor in accordance with another embodiment of the present invention.

FIG. 4 is a frontal perspective view of a methane conversion reactor cooperating with a ventilation system in accordance with another embodiment of the present invention.

FIG. 5 is a frontal perspective view of a pair of methane conversion reactors having a common fan system in accordance with another embodiment of the present invention.

### DETAILED DESCRIPTION OF EMBODIMENTS

The following detailed description contains, for the purposes of explanation, numerous specific embodiments, implementations, examples and details in order to provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the exemplary designs and implementations illustrated and described herein, but may be modified within the scope of the appended claims along with their full scope of equivalents.

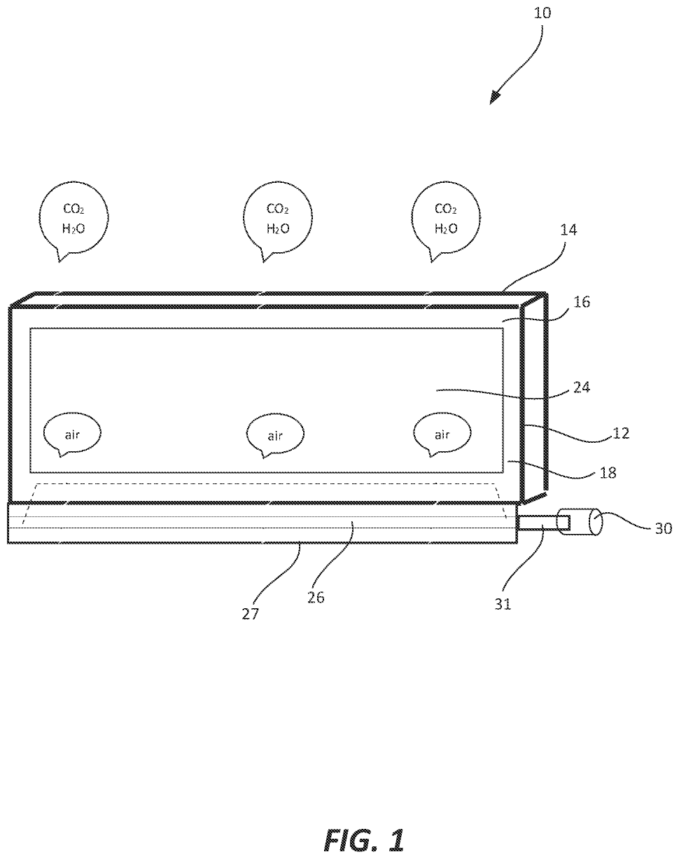

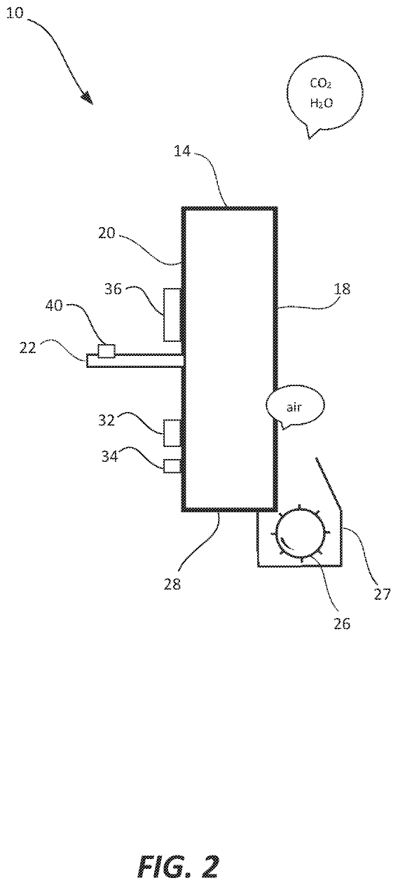

FIGS. 1 and 2 schematically depict a methane conversion reactor denoted generally by reference numeral 10 in accordance with an embodiment of the present invention. The methane conversion reactor 10 is designed to react methane with oxygen in air to convert the methane to carbon dioxide and water vapor. The methane conversion reactor 10 includes a catalytic converter 12 having a housing 14 defining an enclosure 16, the housing 14 having a first face open 18 to atmosphere for receiving air and having a second face 20 that includes a methane inlet 22 for receiving the methane into the enclosure defined by the housing of the catalytic converter. The methane inlet may be connected to a methane supply line or pipe that supplies methane into the methane conversion reactor 10. As will be appreciated, the methane inlet may be connected to a natural gas supply line that contains predominantly methane with small or trace amounts of other gases such as ethane, propane, butane, and pentane.

The methane conversion reactor (MCR) 10 includes a catalyst pad 24 (also known as a catalyst bed) disposed within the housing of the catalytic converter for catalytically reacting the methane with oxygen in the air to produce the carbon dioxide and the water vapor. The MCR 10 includes a centrifugal fan 26 in a fan housing or cage 27 disposed along a side 28 of the housing of the catalytic converter for forcing the air into the housing of the catalytic converter to improve reaction efficiency and to cool the catalyst pad. The MCR 10 includes an electric motor 30 having a drive shaft 31 to drive the centrifugal fan in response to a fan control signal. The MCR 10 further includes a microcontroller 32 for receiving a temperature signal from a temperature sensor 34 and for generating the fan control signal to adjust an air flow rate in response to the temperature signal. In the illustrated embodiment, the fan is disposed along a bottom edge or bottom side of the housing to impel air upwardly across a face of the catalyst pad. The exothermic reaction of converting methane heats the air and reaction products (CO₂ and water vapor) causing all of these gases (air, water vapor and CO₂ to rise), i.e. to move vertically upwardly toward the top of the MCR 10. In one specific embodiment, as depicted in the figures, the centrifugal fan is a squirrel-cage fan extending along an entire bottom side of the housing. In a variant, the fan does not extend the whole length. In another variant, there may be two fans. In another variant, the type of fan may be different.

In one embodiment, the methane conversion reactor comprises an additional catalyst structure 38 disposed along an upper side of the housing to catalytically convert any unconverted methane that rises unreacted from the catalyst pad 24. The additional catalyst structure 38 may be a honeycomb structure or corrugated structure. In this particular embodiment, the additional catalyst structure 38 is orthogonal to the catalyst pad 24 and smaller in surface area than the catalyst pad 24. As shown there may be a gap between the top of the catalyst pad 24 and the additional catalyst structure 38. In a variant, there may be no gap between the catalyst pad 24 and the additional catalyst structure 38 such that one abuts the other.

In one embodiment, the temperature sensor 34 measures a catalyst pad temperature of the catalyst pad 24. The air flow rate generated by the fan 26 may be adjusted automatically to keep the temperature of the catalyst pad 24 within a desired range of operating temperatures that optimize efficiency and promote the longevity of the catalyst in the catalyst pad 24. In another embodiment, the temperature sensor measures an ambient air temperature in a space surrounding the methane conversion reactor. This is useful when the MCR 10 is used a space converter. In this context, the ambient air temperature of the space or room in which the MCR is disposed is measured. If the temperature in the room is too low or too high, the fan speed can be adjusted accordingly.

In one embodiment, the methane conversion reactor 10 includes a thermal electric generator 36, e.g. a Peltier device, for generating electrical power from a thermal gradient in the catalytic converter that is created when the methane reacts exothermically with the oxygen in the air. The electric motor 30 that drives the centrifugal fan 26 is powered by the electrical power generated by the thermal electric generator 36. In other variants, the electric motor may be driven by an external power source, e.g. battery or other energy source.

Optionally, the methane conversion reactor 10 includes a methane flow rate sensor 40 to generate a methane flow signal based on a flow rate of the methane. In that particular implementation, the microcontroller receives the methane flow signal and adjusts the fan control signal in response to the methane flow signal. The methane flow sensor may be disposed in the methane inlet or in any upstream methane supply line or pipe.

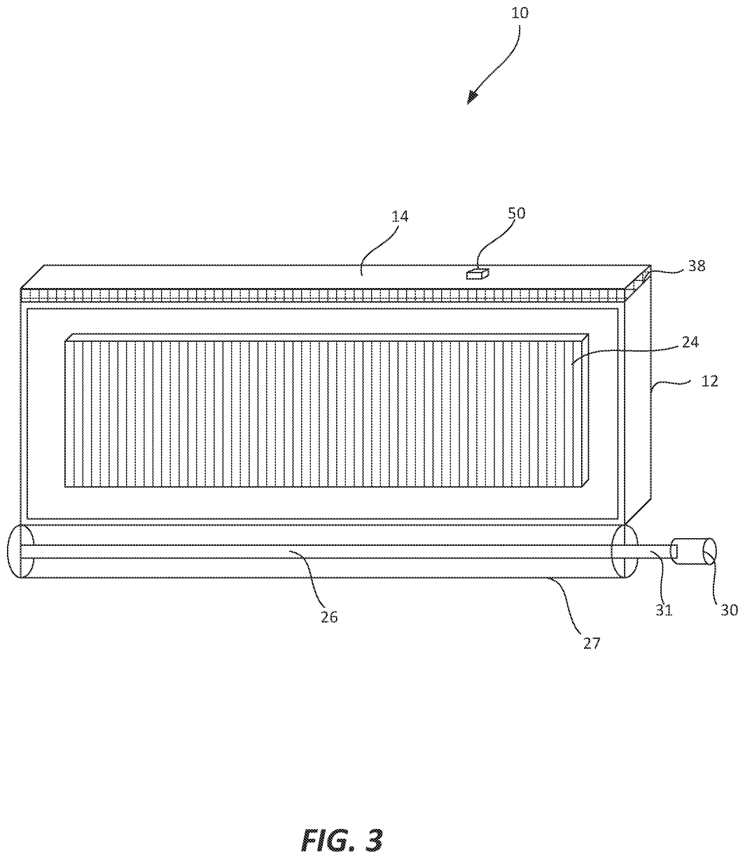

Optionally, as depicted in FIG. 3, the methane conversion reactor 10 comprises a carbon dioxide sensor 50 for generating a carbon dioxide sensor signal based on a concentration of carbon dioxide. In this particular implementation, the microcontroller receives a carbon dioxide sensor signal and adjusts the fan control signal in response to the carbon dioxide sensor signal. In a variant, the MCR 10 may include a humidity sensor to sense water vapour concentration in the ambient air. This may be done to measure the efficiency of the reaction by measuring both incoming methane and the concentration of reaction products. Optionally, the microcontroller may also control venting of a room, shed, industrial facility, or other enclosed space in which the MCR is located. Ventilation may be based on the carbon dioxide sensor signal, i.e. to ventilate the room, shed, industrial facility, or other enclosed space if the level of CO₂ becomes too high. Ventilation may also or alternatively be done to regulate the temperature in the room. The MCR 10 thus is also able to function as a space converter to provide heating of an industrial facility. Optionally, the MCR works in coordination with a ventilation system to ventilate excess heat from the room if the temperature becomes too high.

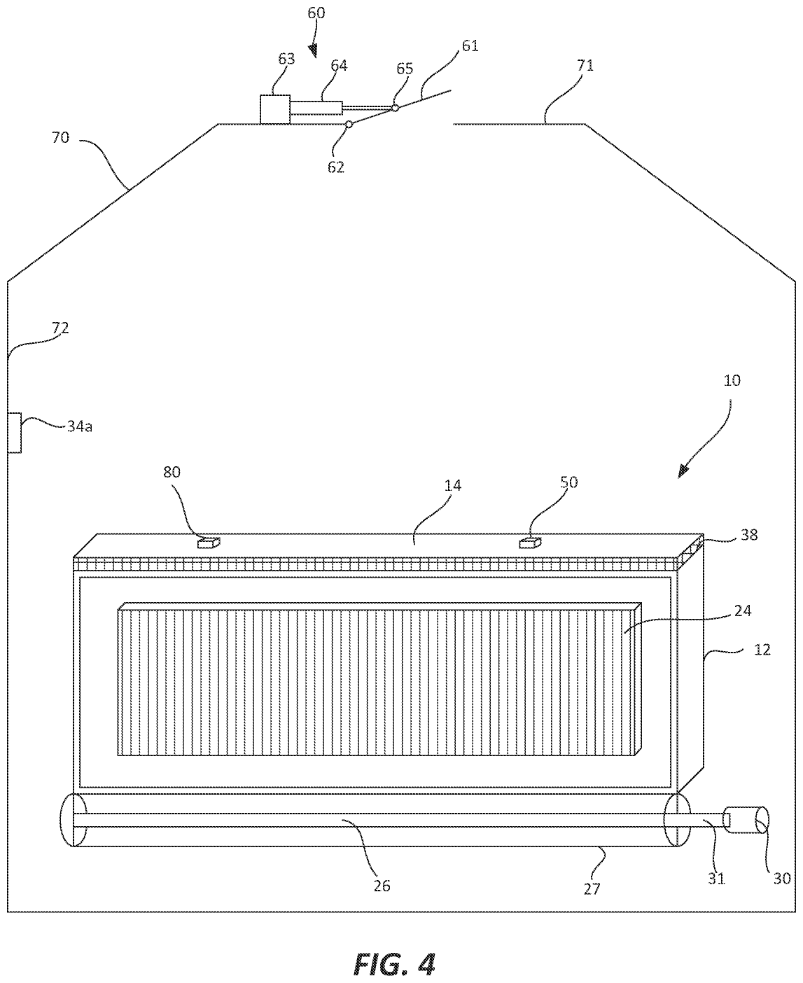

FIG. 4 depicts an example ventilation system 60 that cooperates with the MCR 10 inside a room 70 (i.e. a shed, industrial facility, or other enclosed space) to control the ambient temperature. An ambient air temperature sensor 34a may be attached to a wall 72 or to any other suitable location within the room. The ventilation system 60 may optionally have a vent 61 (i.e. a louver, movable hatch, port, door, etc.) that, for example, pivots about a hinge 62 connected to a roof 71 or to the wall 72 or to any other external portion of the room 70. An actuator controller 63 receives a signal from the MCR to open the vent. The actuator controller 63 sends a control signal to a vent actuator 64 that is connected to the vent by a connector 65 to open or close the vent 61. This ventilation system is simply one example and it will be appreciated that any other suitable ventilation system, mechanism or technique may be employed to ventilate excess heat from the room 70.

Accordingly, the methane conversion reactor (MCR) 10 may operate in conjunction with a ventilation system of a room or building in which the MCR is disposed to regulate the temperature of the room. As shown in FIG. 4, in such an implementation, the ventilation system of the room or building has a vent that enables air and other gases (e.g. carbon dioxide and water vapor) to exit from the room or building, both for temperature management and for ensuring the breathable quality of the air. The vent may be connected to a vent actuator that can open and close the vent as needed. In this example implementation, the microcontroller may optionally be configured to communicate a vent control signal to the vent actuator (connected to the vent of the room in which the methane conversion reactor is disposed) to thereby increase or decrease ventilation based on the temperature signal and a temperature setpoint. The microcontroller may be communicatively connected to a wireless transceiver 80 to communicate wirelessly with the ambient air temperature sensor 34a and the actuator controller 63. Temperature readings may be received wirelessly by the MCR from the ambient air temperature sensor 34a. The microcontroller compares the temperature reading from the ambient air temperature sensor 34a to a temperature setpoint and then adjusts the ventilation to reach the desired setpoint temperature. The setpoint temperature may be set by a user. The microcontroller and wireless transceiver may be used to interface with a smart phone, mobile device or wireless communication device to receive the setpoint temperature from the user. In this implementation, the microcontroller of the MCR controls the ventilation. However, in another implementation, the ventilation may be controlled by a user or its own programmed controller in which case the MCR can receive a signal from the ventilation system to adjust its fan speed based on the ventilations setting. Alternatively, an external thermostat can provide a signal to the MCR to adjust its fan speed based on the thermostat setting. In these latter examples, the MCR receives a signal to adjust its fan speed based upon an external device. Thus, in this alternate implementation, the microcontroller of the MCR can be configured to receive, for example, a vent position signal from a vent controller connected to a vent of a room in which the methane conversion reactor is disposed to thereby increase or decrease the air flow rate in response to the vent position signal.

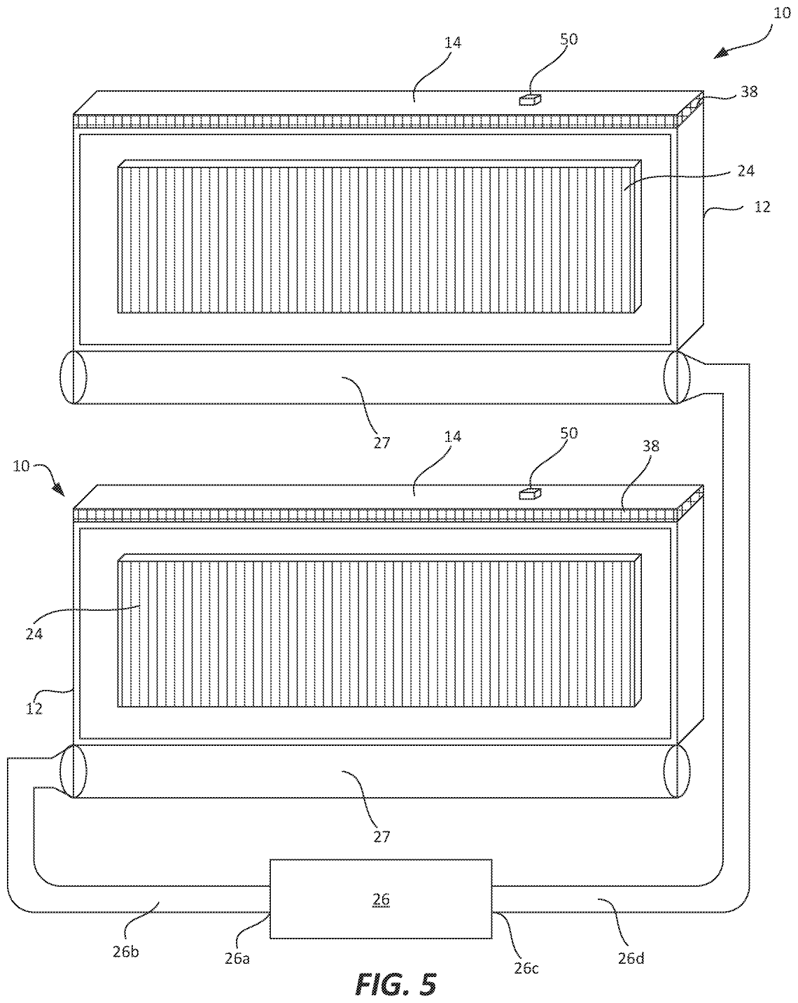

In the foregoing example embodiments, there is one fan for each MCR. However, in other embodiments, there may be one fan for multiple methane conversion reactors. One such example is depicted in FIG. 5 where there are two methane conversion reactors connected to a common fan or air handling unit. FIG. 5 is a frontal perspective view of a pair of methane conversion reactors 10 having a common fan system 26 in accordance with another embodiment of the present invention. In the embodiment of FIG. 5, the common fan system 26 has a first outlet 26a connected to a first duct 26b that delivers forced air to a first MCR 10. The common fan system 26 also has a second outlet 26c connected to a second duct 26d that delivers forced air to a second MCR 10. The common fan system 26 may include a manifold and regulators to control the amount of air delivered to each MCR 10 such that the common fan system can simultaneously deliver different flow rates to each MCR.

In the foregoing embodiments, the fan 26 forces air from a bottom side of the MCR. In a variant, the fan may be placed vertically along one of the vertical sides of the MCR to blow air sideways across the catalyst pad. In a further variant, a suction device or vacuum device may be placed along the top side of the MCR to draw or suck air upwardly from the catalyst pad. In a further variant, the MCR may have both a lower fan and an upper suction device.

The methane conversion reactor 10 described herein is more efficient than prior methane converter reactors. A typical prior-art methane converter reactor having dimensions of, for example, 12″×24″ is able to destroy up to 10,000 BTU/hr (10 SCFH) of methane. However, with a typical prior-art MCR, if the load (flow rate) were to be increased to say 15,000 BTU/hr to 20,000 BTU/hr, the burner's temperature would become too high and the catalyst would be destroyed. In contrast, the MCR 10 described herein uses forced convection to maintain the burner at a lower temperature, thereby enabling the MCR to convert (i.e. neutralize) a greater flow rate of methane. For example, if 20 SCFH has to be neutralized/converted, one would need two prior-art converters of dimension 12″×24″. In contrast, only a single MCR 10 having forced convection can be used to neutralize (convert) the same flow rate of methane. Therefore, less hardware is needed with the new MCR 10. This means that the new MCR 10 is more space-efficient (more compact), i.e. it occupies less space within a given room or industrial facility than two prior-art converters.

The table below presents methane conversion efficiencies:

| | Efficiency-no | Efficiency-with | Air velocity | Efficiency |
|---|---|---|---|---|
| Catalyst | convection | convection | (Feet | gain |
| loading | (%) | (%) | per minute) | (%) |
| regular | 83.6 | 96.5 | 230 | 12.9 |
| 2X regular | 83.6 | 98.7 | 630 | 15.1 |
| 5X regular | 87.1 | 98.5 | 400 | 11.4 |

From the table above, it is apparent that the conversion efficiency with convection (i.e. with the fan running in the new MCR 10) is much higher than the efficiency of a prior-art MCR that does not use convection. It is noted that adding more of the expensive catalyst only slightly improves the efficiency. The above table also reports the optimal air velocity for each catalyst loading.

Another aspect of the present invention is a method of converting methane to carbon dioxide and water vapor. The method entails receiving air into a catalytic converter having a housing defining an enclosure, the housing having a first face open to atmosphere. The method also entails receiving the methane into the enclosure via a methane inlet in a second face of the housing. The method entails catalytically reacting the methane with oxygen in the air to produce the carbon dioxide using a catalyst pad disposed within the housing of the catalytic converter. The method entails forcing the air into the housing of the catalytic converter to improve reaction efficiency and to cool the catalyst pad using a centrifugal fan disposed along a side of the housing of the catalytic converter. The method entails driving, using an electric motor, the centrifugal fan in response to a fan control signal. The method further entails receiving, by a microcontroller, a temperature signal from a temperature sensor. The method further includes generating the fan control signal to adjust an air flow rate in response to the temperature signal.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

1. A methane conversion reactor for reacting methane with oxygen to convert the methane to carbon dioxide and water vapor, the methane conversion reactor comprising:
a catalytic converter having a housing defining an enclosure, the housing having a first face open to atmosphere for receiving air and having a second face that includes a methane inlet for receiving the methane into the enclosure defined by the housing of the catalytic converter;
a catalyst pad disposed within the housing of the catalytic converter for catalytically reacting the methane with oxygen in the air to produce the carbon dioxide and the water vapor;
a centrifugal fan disposed along a side of the housing of the catalytic converter for forcing the air into the housing of the catalytic converter to improve reaction efficiency and to cool the catalyst pad;
an electric motor to drive the centrifugal fan in response to a fan control signal; and
a microcontroller for receiving a temperature signal from a temperature sensor and for generating the fan control signal to adjust an air flow rate in response to the temperature signal.

2. The methane conversion reactor of claim 1 comprising a thermal electric generator for generating electrical power from a thermal gradient in the catalytic converter that is created when the methane reacts exothermically with the oxygen in the air, wherein the electric motor is powered by the electrical power generated by the thermal electric generator.

3. The methane conversion reactor of claim 1 comprising a methane flow rate sensor to generate a methane flow signal based on a flow rate of the methane, wherein the microcontroller receives the methane flow signal and adjusts the fan control signal in response to the methane flow signal.

4. The methane conversion reactor of claim 1 wherein the temperature sensor measures a catalyst pad temperature.

5. The methane conversion reactor of claim 1 wherein the temperature sensor measures an ambient air temperature in a space surrounding the methane conversion reactor.

6. The methane conversion reactor of claim 1 comprising a carbon dioxide sensor for generating carbon dioxide sensor signal based on a concentration of carbon dioxide, wherein the microcontroller receives a carbon dioxide sensor signal and adjusts the fan control signal in response to the carbon dioxide sensor signal.

7. The methane conversion reactor of claim 1 wherein the microcontroller is configured to communicate a vent control signal to a vent actuator connected to a vent of a room in which the methane conversion reactor is disposed to thereby increase or decrease ventilation based on the temperature signal and a temperature setpoint.

8. The methane conversion reactor of claim 1 wherein the microcontroller is configured to receive a vent position signal from a vent controller connected to a vent of a room in which the methane conversion reactor is disposed to thereby increase or decrease the air flow rate in response to the vent position signal.

9. The methane conversion reactor of claim 1 comprising an additional catalyst structure disposed along an upper side of the housing to catalytically convert any unconverted methane that rises unreacted from the catalyst pad.

10. The methane conversion reactor of claim 1 wherein the centrifugal fan is a squirrel-cage fan extending along an entire bottom side of the housing.

11. A method of converting methane to carbon dioxide and water vapor, the method comprising:
receiving air into a catalytic converter having a housing defining an enclosure, the housing having a first face open to atmosphere through the air enter the housing;
receiving the methane into the enclosure via a methane inlet in a second face of the housing;
catalytically reacting the methane with oxygen in the air to produce the carbon dioxide using a catalyst pad disposed within the housing of the catalytic converter;
forcing the air into the housing of the catalytic converter to improve reaction efficiency and to cool the catalyst pad using a centrifugal fan disposed along a side of the housing of the catalytic converter;
driving, using an electric motor, the centrifugal fan in response to a fan control signal;
receiving, by a microcontroller, a temperature signal from a temperature sensor; and
generating the fan control signal by the microcontroller to adjust an air flow rate in response to the temperature signal.

12. The method of claim 11 comprising:
generating electrical power from a thermal gradient in the catalytic converter that is created when the methane reacts exothermically with the oxygen in the air; and
powering the electric motor using the electrical power.

13. The method of claim 11 comprising:
generating a methane flow signal based on a flow rate of the methane;
receiving the methane flow signal by the microcontroller; and
adjusting the fan control signal in response to the methane flow signal.

14. The method claim 11 comprising measuring a catalyst pad temperature using the temperature sensor.

15. The method of claim 11 comprising measuring an ambient air temperature using the temperature sensor.

16. The method of claim 11 comprising:
generating a carbon dioxide sensor signal based on a concentration of carbon dioxide;
receiving by the microcontroller the carbon dioxide sensor signal; and
adjusting the fan control signal in response to the carbon dioxide sensor signal.

17. The method of claim 11 comprising communicating by the microcontroller a vent control signal to a vent actuator connected to a vent of a room to thereby increase or decrease ventilation based on the temperature signal and a temperature setpoint.

18. The method of claim 11 comprising receiving by the microcontroller a vent position signal from a vent controller connected to a vent of a room and adjusting the air flow rate in response to the vent position signal.

19. The method of claim 11 comprising catalytically converting unconverted methane that rises unreacted from the catalyst pad using an additional catalyst structure disposed along an upper side of the housing.

20. The method of claim 1 wherein the centrifugal fan is a squirrel-cage fan extending along an entire bottom side of the housing.
